(19) United States
(12) Patent Application Publication
(10) Pub. No.: US 2004/0055220 A1
(43) Pub. Date: Mar. 25, 2004

(54) Child safety device

(76) Inventor: Rick Edward Lohman, Vancouver, WA (US)

Correspondence Address: RICK EDWARD LOHMAN, 3016 NE 136th AVE., VANCOUVER, WA, 98682, US

(21) Appl. No.: 10/665,967

(22) Filed: Sep. 18, 2003

Related U.S. Application Data
(60) Provisional application No. 60/412,383, filed on Sep. 20, 2002.

(51) Int. Cl. E05F 3/00

(52) U.S. Cl. 49/322; 16/82; 52/207

(57) ABSTRACT

The present invention is a unitary device molded from rubber or other synthetic elastic materials and is lightweight and inexpensive to manufacture. The safety device has multi tasking capabilities to help protect children's fingers from a number of injurious situations i.e., patio sliding doors, sliding windows, swinging doors, sliding closet doors and the like.

The improvements flexible curved embodiment generates a force when bent that is applied as tension to two extrusions which grasp to attach the device to the sliding member of a sliding closure assembly, or attach the device to the swinging door of a swinging door assembly. The embodiments breadth and depth, block and stop the sliding member or swinging door from making an abutment with the frame. The embodiments depth creates a safety gap between the sliding member or swinging door and the frame to protect children's fingers.

### TECHNICAL FIELD

The present invention relates to a child safety device for protecting children's fingers from the accidental closings of sliding doors and sliding windows and the like. The present invention relates to a safety device for protecting children's fingers from unnecessary injury from sliding closet doors, screen doors, sliding cabinets, sliding cupboards or any sliding panels, partitions or the like. The present invention relates to a child safety device for protecting children's fingers from the inadvertent closing of swinging doors within the home, such as interior doors used between hallways, bedrooms, bathrooms and exterior entry doors.

### BACKGROUND OF THE INVENTION

Many child safety products have evolved in recent years to address the numerous everyday devices, which pose potentially hazardous situations for children, especially for infants and toddlers. For example, child safety gates for stairways, latches and locks to deny access to drawers and cupboards as well as plugs to cover electrical outlets, just to mention a few. Patio sliding doors and sliding windows are yet another potentially hazardous situation for children's fingers. A patio sliding door or sliding window with sufficient thrust or momentum can cause serious injury to unsuspecting fingers if impacted between the sliding door or sliding window and it's frame.

The patio sliding door in most homes is the primary access to the backyard for play and other activities for children. Fair weather or a grouping of children, increases the use of patio sliding doors and the surrounding area can become a hub for small children, accordingly increasing the likelihood of inadvertent closings on children's fingers.

Prior art has addressed this potential safety hazard with various safety devices to prevent injury to children's fingers from the accidental closing of sliding doors and swinging doors. However all prior art demonstrates common and distinct disadvantages to the present invention.

Prior art consists of mechanical devices requiring tools and various fastening methods to attach the device to the sliding member or to the frame. The present invention requires no tools or fasteners.

Quote from U.S. Pat. No. 5,740,585 Shapiro discloses a sliding door device in which a sliding closure assembly according to claim 1, wherein said attachment member includes a Velcro.RTM. portion by which it is attached to said frame.

Additionally, prior art safety devices possess interconnected components comprising of screws, pins, rods, knobs, springs, straps, and the like. The present invention is a unitary elastic device that has no parts, therefore eliminating any need for repair or replacement parts.

Quote from U.S. Pat. No. 4,165,553 Salerno discloses a sliding door device in which a resilient ball is attached to a string.

Quote from U.S. Pat. No. 6,073,306 Warren discloses a sliding door device in which one or both finger grips 23 would first be removed, then pin 21 would be removed as by hand or with an appropriate tool.

All prior art demonstrates a singular function. The present invention demonstrates great utility and versatility with multi tasking capabilities.

An object of the present invention is to provide an improved safety device to protect children's fingers from the accidental closing of patio sliding doors, sliding windows, sliding screen doors, sliding closet doors, sliding cabinets, sliding cupboards and the like.

An object of the present invention is to provide an improved safety device to prevent injury from slamming or pinching of fingers from swinging doors within the home. Swinging doors include interior doors used between hallways, bathrooms, bedrooms and the like, including the exterior entry doors.

An object of the present invention is to provide a safety device that demonstrates utility and versatility by means of multi tasking capabilities i.e., the device was attached to the patio sliding door while the children played outside, then can be removed and placed on the bedroom door while they play in the bedroom.

Another object of the present invention is to provide a device with the flexibility and capabilities to accommodate the many profiles and thicknesses within the door and window industry, which includes vinyl sliding doors and sliding windows, wood sliding doors and sliding windows, metal sliding doors and sliding windows and swinging doors.

Another object of the present invention is to provide a unitary molded device with the proper material composition that demonstrates impact absorption, abates bounce back and displays durability and resiliency.

Another object of the present invention is to provide a device that is lightweight, inexpensive and easily manufactured in a variety of sizes.

And another object of the present invention is to provide a device that visually conveys simplicity in function and convenience for the user.

Other and further objects of the present invention will become apparent upon an understanding of the illustrative embodiments about to be described, or will be indicated in the appended claims, and various advantages not referred to herein will occur to one skilled in the art upon employment of the invention in practice.

### BRIEF SUMMARY OF THE INVENTION

A sliding closure assembly consisting of a frame and a sliding member that is slide able within the frame, said sliding member is positioned between the open position and the closed position. A swinging door assembly consisting of a frame and a swinging door which is positioned between the open position and the closed position.

The safety device is a unitary device molded from rubber or other synthetic elastic compositions. The device can be easily attached to the sliding member or the swinging door, and prevent injury to children's fingers from the accidental closing of sliding members or swinging doors. The device blocks and stops the sliding member or swinging door and provides a safety gap to prevent fingers from being impacted between the sliding member and the frame or the swinging door and the frame. The device has advantages over prior art considering no tools are required for attachment, repair or replacement parts. Another advantage is the device is not stationary once attached like prior art. The device is capable of multi tasking from one location or function to another.

### BRIEF DESCRIPTION OF THE DRAWINGS

The present invention is a unitary device shown in FIG. 1, the device 1 has an embodiment which is curved. The bottom of the device is convex 2 and the top is concave 3, the convex curve and concave curve intersect with a radius at the vertex of the curved embodiment. Two round opposing extrusions 4 extend from the concave surface and are separated by a spacing which is reserved for accommodation. As seen in FIG. 2, the index fingers are placed on top of each round opposing extrusion and the thumbs are placed on the convex curve. By flection of the convex curve and the stretching of the concave curve, the opposing extrusions open and the embodiment elongates and flattens out to accommodate the sliding member or swinging door. The action generates an energy force that is stored up in the embodiment until released. This force becomes the tension that securely attaches the device to the sliding member or swinging door as seen in the figures. The relieves shown in FIGS. 1-5, allow the opposing extrusions to pivot out if necessary to accommodate the maximum thickness of the sliding member or swinging door. The device is attached at right angles to the sliding member or swinging door as seen in FIGS. 5 & 8. When the device is open it is positioned over the leading edge of the sliding member or swinging door until the concave surface makes abutment with the leading edge as shown in FIGS. 4,6,7, then the device can be released by the user, at which time the stored up energy of the embodiment is applied as tension to the two opposing extrusions which are now located at the sides of the sliding member or swinging door as shown in FIGS. 4,6,7.

FIG. 3 is a top view of a typical patio sliding door assembly showing that the leading edge of the sliding member 6 has passed through the channeling 7 and made an abutment with the frame bottom.

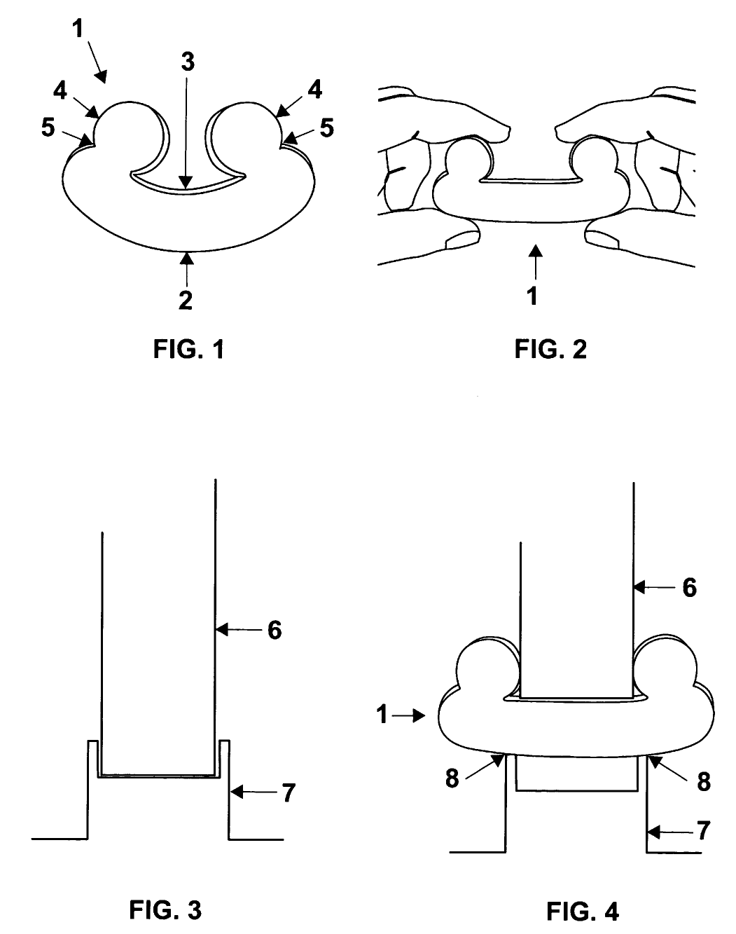

FIG. 4 is a top view of the same patio sliding door assembly with the safety device 1 attached to the leading edge of the sliding member 6. When an attempt to close the sliding member is made, the device makes contact with both sides of the channeling leading edges 8, where the devices breadth overrides the channeling gap, therefore blocking the leading edge of the sliding member from entering the channeling 7 to make abutment, thereby stopping the sliding member at a distance equal to the depth of the device, creating a paralleling safety gap between the sliding member and the frame, running the entire vertical length of the sliding assembly.

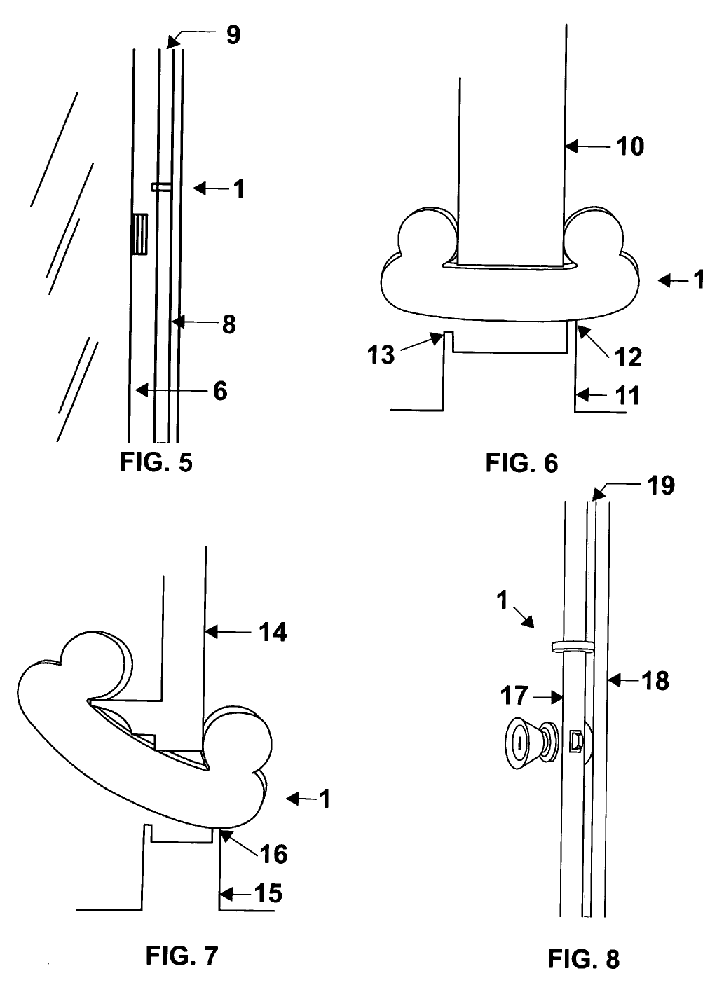

Illustrated in FIG. 5 is a side view of the same patio sliding door assembly. The view demonstrates the safety gap created by the safety device. The device is shown attached at the preferred location which is out of the children's reach and as close to the center of the sliding member as possible. The sliding member 6 has been blocked and stopped by the device when contact is made between the device 1 and the channeling leading edges 8, providing a safety gap 9 to protect children's fingers from being impacted between the sliding member and the frame.

Some sliding assembly channeling may have leading edges that are not equal in length as seen in FIG. 6. The safety device is attached to a typical vinyl sliding window assembly. The device 1 is attached to the leading edge of the sliding member 10, when an attempt is made to close the sliding member into channeling 11, the device makes contact with only one side of the channeling leading edges 12. The channeling leading edge 12 extends further then the other leading edge 13. The safety device remains securely in place regardless of making contact with only the one side of the channeling.

Metal sliding window assemblies are manufactured with an array of different configurations on the sliding member leading edges. Shown in FIG. 7 is a typical metal sliding window assembly. Sliding member 14 shows a leading edge configuration of a sliding metal window. Regardless of the varying extrusions that make up the configuration of the leading edge, the device 1 has the ability to accommodate the profile and grasp the rims and ridges for a sure grip and remains securely in place. The device will make contact with the channeling 15 at one of the channeling leading edges 16 or both, providing a safety gap of at least the depth of the device.

To further demonstrate the utility and versatility of the present invention, FIG. 8 illustrates the device 1 attached to a typical bedroom door 17 which swings to close. The device prevents a complete closure by making contact with the door frame or casing 18 and is blocked from closing, providing a safety gap 19 which runs the entire length of the door.

The device can easily be attached in the same fashion to sliding closet doors, screen doors, sliding cabinets, sliding cupboards and other sliding panels or partitions as needed.

While the present invention has been described by means of specific examples and in a specific embodiment, I do not wish to be limited thereto for obvious modifications can and will occur to those skilled in the art without departing from the spirit and scope of the invention.

### DETAILED DESCRIPTION OF THE INVENTION

Patio sliding doors and sliding windows are a componential sliding assembly comprising of a channeled framework, with two or more partitions retained within the channeling, constituting a whole sliding assembly. One partition or member remains fixed within the channeling, and the other member or members are slidable between the open and closed position. To obtain closure or abutment, the leading edge of the sliding member must enter the channeling before making an abutment with the frame bottom.

Swinging door assemblies included in this particular application consist of interior and exterior doors within the home i.e., bedroom doors, bathroom doors, closets doors, entry doors and the like.

In order to provide an improved safety device that is simple, lightweight and inexpensive to produce with all the capabilities discussed herein, the present invention is preferably molded as a unitary device from rubber or any of the numerous synthetic elastic materials of varying chemical compositions with properties similar to those described for the preferred material composition of the present invention. The present invention demonstrates a flexibility and capability to be stretched to accommodate a broad range of door and window thick nesses and profiles within the door and window industry. The preferred material composition demonstrates a low compression set and a hardness range to produce a device that absorbs impact, abates bounce back and displays resiliency and durability.

The embodiment comprises a curvature with a breadth and depth, the top being concave and the bottom is convex. A radius intersects the concave and the convex at the vertex of the curved embodiment. Two round opposing extrusions extend from the concave surface separated by a distance, which is reserved for accommodation.

The index fingers are placed on the top of each extrusion and the thumbs are placed on the convex bottom. By pushing in on the convex bottom and pulling apart the extrusions in one simultaneous action the embodiment elongates and flattens and stretches the concave curve, opening the extrusions generating an energy force which is stored in the embodiment. The device is positioned on the leading edge of the sliding member or the swinging door then released. The stored up force is now utilized as a tension through the extrusions to be attached by applying pressure to the sides of the sliding member or the swinging door.

The device attaches to the sliding member of a sliding closure assembly and the swinging door of a swinging door assembly. The device blocks and stops the sliding member or the swinging door at a distance equal to the embodiments depth creating a safety gap to protect children's fingers from being impacted between the sliding member and the frame or the swinging door and the frame.

1. A sliding closure assembly consisting of a frame and a sliding member which is slidable within the frame between the open position and the closed position. A swinging door assembly consisting of a frame and a swinging door which is positioned between the open position and the closed position. When the safety device is properly positioned on said sliding member or said swinging door, the device blocks and stops the sliding member or the swinging door at a distance from the frame equal to the depth of the device, creating a safety gap to protect children's fingers from impact between the sliding member and the frame, or the swinging door and the frame. The safety device comprises two round opposing extrusions that grasp to make attachment to the sliding member or swinging door. The grasping capability is derived from the flexion of the devices curved flexible embodiment.

2. The safety device according to claim 1, comprises a curved and flexible embodiment which when bent and stretched generates a force which is applied as tension to the two round opposing extrusions for attachment. The embodiments depth provides the safety gap between the sliding member and the frame, or the swinging door and the frame.

3. The safety device according to claim 1, consists of rubber or any other synthetic elastic compositions.
